(19) United States
(12) Patent Application Publication
(10) Pub. No.: US 2005/0204546 A1
(43) Pub. Date: Sep. 22, 2005

(54) Method of forming induction coil and product thereof

(75) Inventor: Huo-Li Lin, Taipei City (TW)

Correspondence Address: DENNISON, SCHULTZ, DOUGHERTY & MACDONALD, 1727 KING STREET, SUITE 105, ALEXANDRIA, VA, 22314, US

(73) Assignee: TRIO TECHNOLOGY CO., LTD.

(21) Appl. No.: 10/804,116

(22) Filed: Mar. 19, 2004

(51) Int. Cl. B31F 1/00

(52) U.S. Cl. 29/602.1; 29/605; 29/604

(57) ABSTRACT

A method of forming induction coil includes the steps of processing a metal material to form a long flat strip having a beginning section, a plurality of middle sections, and an end section that are integrally and sequentially connected to one another; subjecting the sections of the flat strip to necessary surface isolating treatment; and sequentially folding the flat strip at joints of two adjacent middle sections to forma folded section at each joint, and stacking while folding the middle sections one by one to form a frame-type multi-layered coil structure with the folded sections on two adjacent layers of middle sections staggered by an angle without locating on the same vertical axis. The induction coil is durable because the staggered folded sections protect the coil structure against short circuit possibly caused by any damaged surface isolation at any folded section due to deformation thereof.

### FIELD OF THE INVENTION

The present invention relates to a method of forming an induction coil and a product thereof. In the method of the present invention, a metal strip is processed to form a plurality of middle sections, any two adjacent ones of which are folded at a joint thereof and sequentially stacked to form a multi-layered coil structure that is adapted to prevent short circuit due to any insulating damage between two adjacent layers of the coil.

### BACKGROUND OF THE INVENTION

An induction coil is one type of current-carrying conductor. When an amount of current is supplied to the current-carrying conductor, a magnetic field is produced. Therefore, the current-carrying conductor may be used to manufacture different electronic components, such as coils, inductances, or transformers. The current-carrying conductor or coil portion of an electronic component, such as the above-mentioned coils, inductances or transformers, is usually formed by way of winding a metal material that has been subjected to necessary surface isolating treatment.

In a condition where relatively large current is to be carried, the metal material must have a relatively large current-carrying cross section. Typically, a flat metal strip is substituted for the normally used metal wire in this condition.

FIG. 1 is a schematical view showing the process of forming a conventional induction coil, and FIGS. 2 and 3 are perspective and sectional views, respectively, of the conventional induction coil formed with the process of FIG. 1. As can be seen from FIG. 1, in the conventional process of forming a coil structure from a metal sheet 1, the metal sheet 1 is first cut into straight strips 11, which are subjected to necessary surface isolating treatment, such as an insulating treatment, and then, the individual straight strip 11 is directly spirally wound to produce multiple layers and form a frame-type multi-layered coil structure, such as a round frame-type multi-layered coil structure.

A disadvantage is found in the above-described process for forming induction coil as well as in the induction coil so produced. That is, when the straight metal strip 11 is wound to form the frame-type multi-layered coil structure having a wound body 12, portions of the metal strip 11 in the wound body 12 are changed from an originally straight shape into a curved shape, such as an annular flat ring 13. In the course of changing the shape, an inner circumferential edge 13a of the annular flat ring 13 is subjected to compression while an outer circumferential edge 13b of the annular flat ring 13 is stretched. The surface isolating treatment, such as a layer of insulating paint, applied to the metal strip 11 will possibly break at one or more of the stretched outer circumferential edge 13b at the wound body 12 to damage the insulation of the produced induction coil. In the event a damage point 14 exits at two corresponding positions on two adjacent layers of annular rings 13 of the wound body 12, as shown in FIG. 3, a short circuit will occur.

### SUMMARY OF THE INVENTION

A primary object of the present invention is to provide a method of forming induction coil that eliminates the shortcoming of the above-described conventional induction coil to ensure good yield of induction coil without the risk of short circuit.

To achieve the above and other objects, the method of forming induction coil according to the present invention includes the steps of processing a metal material to form a long flat strip having a beginning section, a plurality of middle sections, and an end section that are integrally sequentially connected to one another; subjecting the sections of the flat strip to necessary surface isolating treatment; and sequentially folding the flat strip at joints of two adjacent middle sections to form a folded section at each joint, and stacking while folding the middle sections one by one to form a frame-type multi-layered coil structure with the folded sections on two adjacent layers of middle sections staggered by an angle without locating on the same vertical axis.

The induction coil formed using the method of the present invention includes a flat metal strip having a beginning section, a plurality of middle sections sequentially integrally extended from the beginning section, and an end section integrally extended from the last one of the middle sections. The middle sections are sequentially folded at joints of any two adjacent ones, so as to form a folded section at each joint. The middle sectioned are stacked one by one while being folded at the joints, so as to form a frame-type multi-layered coil structure with the folded sections on two adjacent layers being circumferentially staggered by a predetermined angle without locating on the same vertical axis.

The induction coil formed using the method of the present invention is durable because the staggered folded sections protect the coil structure against short circuit possibly caused by any damaged surface isolation at any folded section due to deformation thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the process of forming a conventional induction coil;

FIG. 2 is a perspective view of a conventional induction coil formed with the process of FIG. 1;

FIG. 3 is a sectional view of FIG. 2;

FIG. 4 shows an induction coil of the present invention in an extended state before being folded;

FIG. 5 schematically shows the steps of folding the extended induction coil of FIG. 4;

FIG. 6 is a fragmentary and enlarged view of FIG. 5;

FIG. 7 is a top perspective view of a finished induction coil formed by folding as in FIG. 5; and

FIG. 8 is an induction coil according to another embodiment of the present invention in an extended state before being folded.

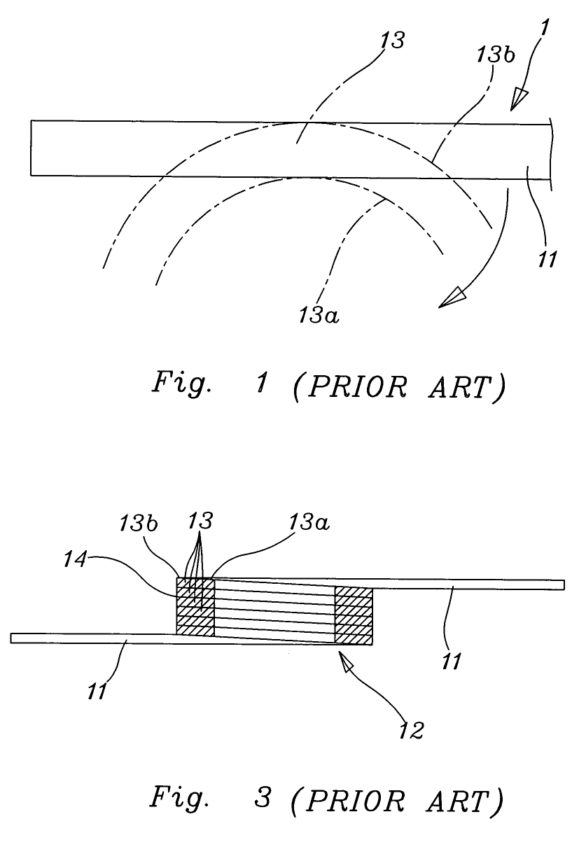

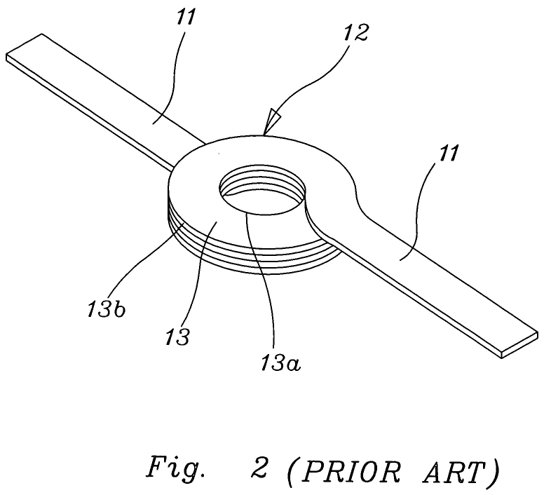

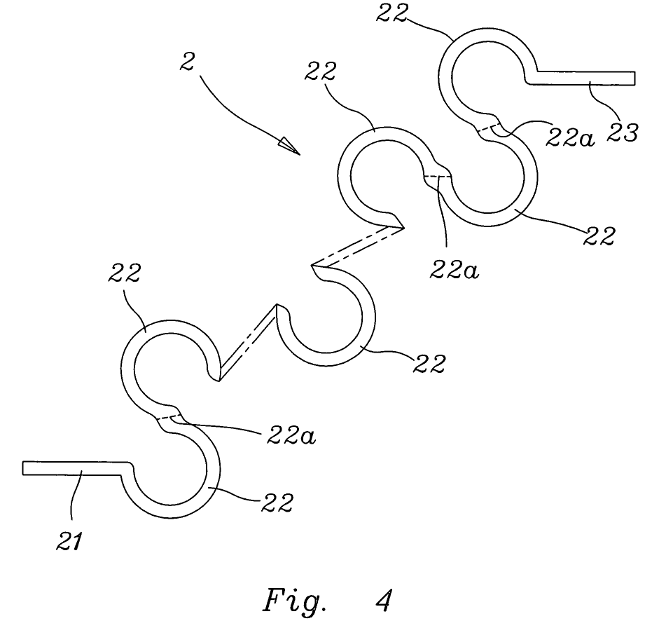

### DETAILED DESCRIPTION OF THE PREFERRED EMBODIMENTS

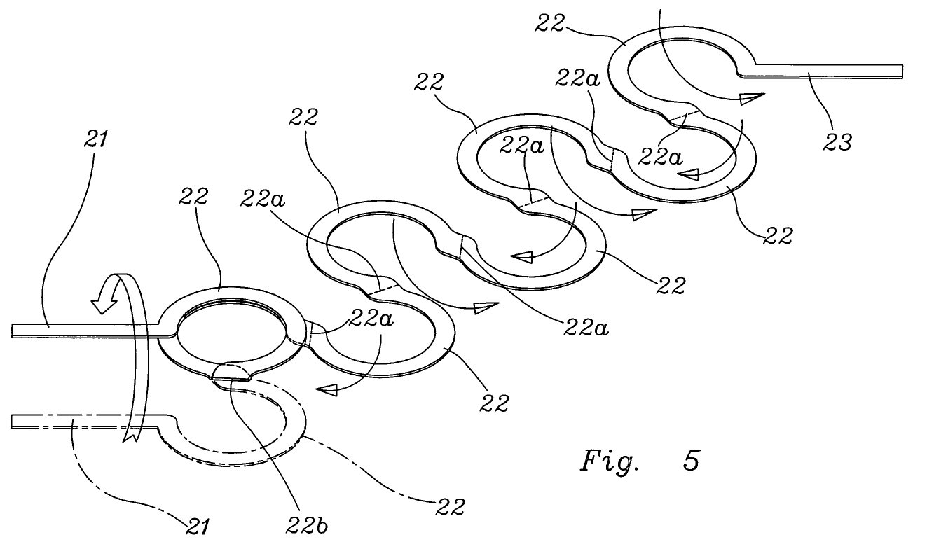

Please refer to FIG. 4 that shows a first step of forming an induction coil 2 of the present invention. As shown, to form an induction coil 2 of the present invention, first prepare a piece of predetermined metal material, which is, for example, pressed, cut, etched, and/or cast to form a long flat metal strip having a beginning section 21, a plurality of middle sections 22, and an end section 23, all of which are integrally and sequentially connected to one another, as shown in FIG. 4.

Then, the sequentially connected beginning section 21, middle sections 22, and end section 23 are subjected to necessary surface isolating treatment, such as an insulating treatment over the surface of the whole metal strip.

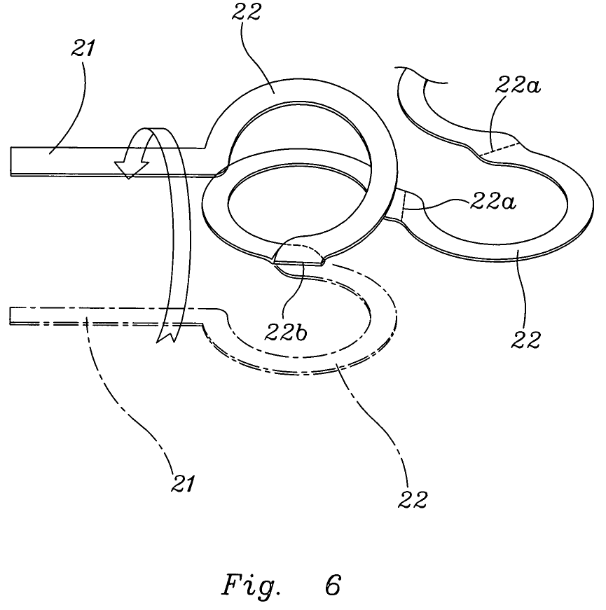

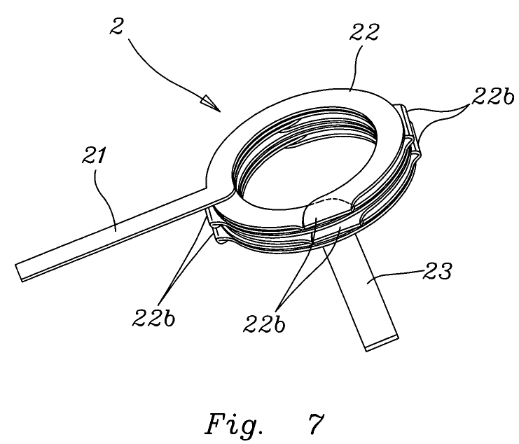

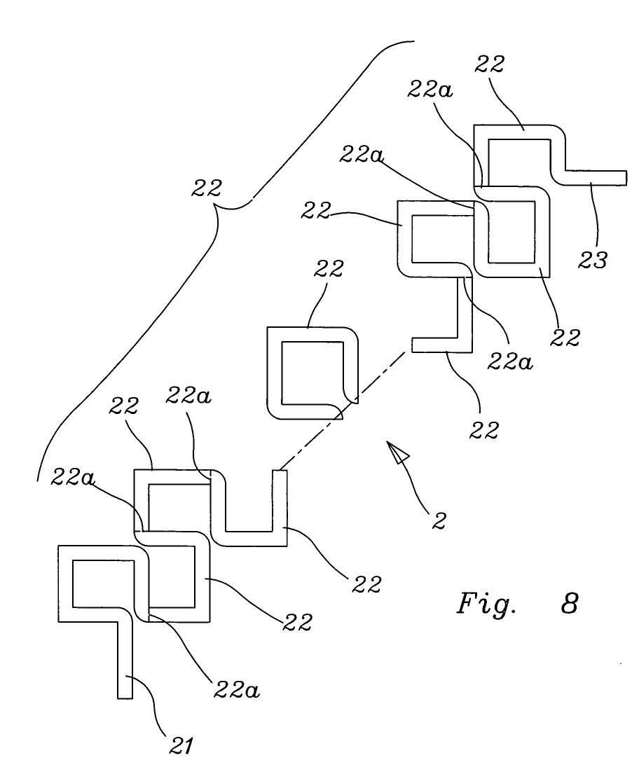

Finally, sequentially fold the plurality of middle sections 22 at joints 22a of two adjacent middle sections 22, so that a folded section 22b is formed at each joint 22a. Please refer to FIG. 5 that shows the manner of folding the middle sections 22 and to FIG. 6 that is a fragmentary enlarged view of FIG. 5. As shown in FIG. 5, the middle sections 22 are sequentially folded at the joints 22a in directions as indicated by the arrows, so that the folded middle sections 22 are stacked to form a frame-type multi-layered coil structure as shown in FIG. 7. It is noted the folded sections 22b at two adjacent layers of middle section 22 on the so formed frame-type coil structure are staggered by a certain angle without locating at the same vertical axis. In the embodiment of the present invention shown in FIGS. 4 to 7, two folded sections 22b on two adjacent layers of the coil structure are circumferentially spaced from one another by 90 degrees.

In the frame-type multi-layer coil structure formed by sequentially folding and stacking the plurality of middle sections 22 in the manner shown in FIG. 5, each turn or each layer of the coil may comprise either the same one middle section 22, different middle sections 22, or parts of some different middle sections 22.

The middle sections 22 may be of any shape, so long as the shape allows the middle sections to be folded at the joints 22a and stacked to form a frame structure for the induction coil 2. For instance, the embodiment of the induction coil 2 of the present invention shown in FIGS. 4 to 7 has substantially round-shaped middle sections 22 that can be folded and stacked to form a frame-type coil having a round cross section. FIG. 8 shows another embodiment of the present invention, in which the middle sections 22 are substantially square-shaped and can be folded and stacked to form a frame-type coil having a square cross section.

The beginning section 21 and the end section 23 are for electrical connection to other electric circuits. By changing the shapes, the dimensions, or the sizes of the beginning and the end section 21, 23, it is possible to change the shapes, or the lead-out positions or angles ofthebeginningandtheendsection21, 23, respectively. Alternatively, it is possible to change the lead-out positions or angles of the beginning and the end section 21, 23 by changing the shapes, the dimensions, or the sizes of the middle sections 22 that are connected to the beginning and the end sections 21, 23, respectively.

On the induction coil formed with the method of the present invention, the folded sections 22b at two adjacent layers of middle sections 22 are staggered without locating on the same vertical axis. Therefore, any damage of the surface isolating treatment at any folded section 22b due to deformation caused by folding would not result in a short circuit at that folded section 22b and the middle section 22 at the adjacent layer, and the good quality of the induction coil 2 in use can be maintained. In other words, the induction coil 2 of the present invention formed by folding and stacking the plurality of middle sections 22 eliminates the problem of short circuit that is easily found in the conventional induction coil formed by winding, while it provides the same effect as that of the conventional induction coil.

1. A method of forming induction coil, comprising the steps of:
preparing a predetermined metal material and processing it to form a long flat strip having a beginning section, a plurality of middle sections, and an end section, all of which being integrally and sequentially connected to one another;
having said beginning section, said middle sections, and said end section of said flat strip subjected to necessary surface isolating treatment; and
sequentially folding said flat strip at joints of two said middle sections that are adjacent to one another, so that a folded section is formed at each said joint and said middle sections are stacked one by one while being folded to form a frame-type multi-layered coil structure with said folded sections on two adjacent layers of said stacked middle sections being circumferentially staggered by a predetermined angle without locating on the same vertical axis.

2. The method of forming induction coil as claimed in claim 1, wherein said metal material is pressed to form said long flat strip having said sequentially arranged beginning section, middle sections, and end section.

3. The method of forming induction coil as claimed in claim 1, wherein said metal material is cut to form said long flat strip having said sequentially arranged beginning section, middle sections, and end section.

4. The method of forming induction coil as claimed in claim 1, wherein said metal material is etched to form said long flat strip having said sequentially arranged beginning section, middle sections, and end section.

5. The method of forming induction coil as claimed in claim 1, wherein said metal material is cast to form said long flat strip having said sequentially arranged beginning section, middle sections, and end section.

6. The method of forming induction coil as claimed in claim 1, wherein said middle sections are in any shape that allows said middle sections to be sequentially folded and stacked to form said frame-type coil.

7. The method of forming induction coil as claimed in claim 1, wherein each layer of said multi-layered coil structure comprises the same said middle section or different ones of said middle sections.

8. The method of forming induction coil as claimed in claim 1, wherein each layer of said multi-layered coil structure comprises parts of some different middle sections.

9. The method of forming induction coil as claimed in claim 1, wherein said beginning section of said long flat strip has a lead-out position or angle that can be changed by way of changing a shape, dimensions, or a size of said middle section that is connected to said beginning section.

10. The method of forming induction coil as claimed in claim 1, wherein said beginning section of said long flat strip has a lead-out position or angle that can be changed by way of changing a shape, dimensions, or a size of said beginning section.

11. The method of forming induction coil as claimed in claim 1, wherein said end section of said long flat strip has a lead-out position or angle that can be changed by way of changing a shape, dimensions, or a size of said middle section that is connected to said end section.

12. The method of forming induction coil as claimed in claim 1, wherein said end section of said long flat strip has a lead-out position or angle that can be changed by way of changing a shape, dimensions, or a size of said end section.

13. An induction coil structure formed from a flat metal strip having been subjected to necessary surface isolating treatment, comprising:
a beginning section;
a plurality of middle sections integrally and sequentially extended from said beginning section, said middle sections being sequentially folded at joints of any two adjacent ones of said middle sections, so as to form a folded section at each of said joints; said middle sectioned being stacked while being folded at said joints one by one, so as to form a frame-type multi-layered coil structure; and said folded sections on two adjacent layers being circumferentially staggered by a predetermined angle without locating on the same vertical axis; and an end section integrally extended from the last one of said middle sections.

14. The induction coil structure as claimed in claim 13, wherein said middle sections are in any shape that allows said middle sections to be sequentially folded and stacked to form said frame-type coil structure.

15. The method of forming induction coil as claimed in claim 13, wherein each layer of said multi-layered coil structure comprises the same said middle section or different ones of said middle sections.

16. The method of forming induction coil as claimed in claim 13, wherein each layer of said multi-layered coil structure comprises parts of some different middle sections.

17. The method of forming induction coil as claimed in claim 13, wherein said beginning section of said long flat strip has a lead-out position or angle that can be changed by way of changing a shape, dimensions, or a size of said middle section that is connected to said beginning section.

18. The method of forming induction coil as claimed in claim 13, wherein said beginning section of said long flat strip has a lead-out position or angle that can be changed by way of changing a shape, dimensions, or a size of said beginning section.

19. The method of forming induction coil as claimed in claim 13, wherein said end section of said long flat strip has a lead-out position or angle that can be changed by way of changing a shape, dimensions, or a size of said middle section that is connected to said end section.

20. The method of forming induction coil as claimed in claim 13, wherein said end section of said long flat strip has a lead-out position or angle that can be changed by way of changing a shape, dimensions, or a size of said end section.
